(19) United States
(12) Patent Application Publication
(10) Pub. No.: US 2017/0271795 A1
(43) Pub. Date: Sep. 21, 2017

(54) ELECTRICAL CONNECTOR DEVICE

(71) Applicant: XIAMEN ECO LIGHTING CO. LTD., Xiamen (CN)

(72) Inventors: Maojin Zeng, Xiamen (CN); Xiaobo Chen, Xiamen (CN); Tian Zhang, Xiamen (CN); Yongjun Bao, Xiamen (CN); Yongzhe Dong, Xiamen (CN)

(21) Appl. No.: 15/508,485

(22) PCT Filed: Jul. 8, 2016
(86) PCT No.: PCT/CN2016/089430

§ 371 Date: Mar. 2, 2017

(30) Foreign Application Priority Data
Nov. 27, 2015 (CN) 201510843759.0

(51) Int. Cl. H01R 12/71; F21V 23/00; F21V 23/06; F21V 19/00; H01R 13/11; H01R 12/70

(52) U.S. Cl. CPC H01R 12/718; H01R 13/113; H01R 12/7076; H01R 12/7082; F21V 23/06; F21V 19/003; F21V 23/004

(57) ABSTRACT

An electrical connector device that connects a light source board and a driver board of an LED light electrically. The electrical connector device includes a connector board. The connector board is related to the conductive pins. The connector board is fixed on the light source board and connected to the light source board electrically through the conductive pins. The electrical connector device also includes two electrical connector pieces. Each electrical connector piece includes a whole set for the connection portion and the resistance portion. One end of the connection portion is fixed on the connection board. The resistance portion of the electrical connector piece closes to each other to become an elastic clipping portion and includes the bent and fastening structure. After bending, the fastening structure touches the other end of the connection portion to be fixed on the connection board. The electrical connector device owns the advantages of simple structure and easy to be assembled automatically.

### TECHNICAL FIELD

The present invention is related to a lighting field and more particularly related to an electrical connector device.

### BACKGROUND

With the rising of the global environmental awareness, a LED light has developed rapidly in the lightning field. In present LED light tube's socket structure, using artificial welding lead is the common way to connect the electricity from socket to driver board. Connecting two leads through the electricity on driver board to achieve the purpose of the connection in driving two ends of electricity. The connecting way is not conducive for automated production. It needs artificial threading and welding lead. It complexes the production process, lowers the production efficiency, wastes the time and is not good at positioning and installing.

### SUMMARY OF INVENTION

In view of this, it is necessary to provide the electrical connector device with a simple structure and an easy combination.

The technical solution for the present invention is an electrical connector device that connects a light source board and a driver board of an LED light electrically. The electrical connector device includes a connector board. The connector board is related to the conductive pins. The connector board is fixed on the light source board and connected to the light source board electrically through the conductive pins. The electrical connector device also includes two electrical connector pieces. Each electrical connector piece includes a whole set for the connection portion and the resistance portion. One end of the connection portion is fixed on the connection board. The resistance portion of the electrical connector piece closes to each other to become an elastic clipping portion and includes the bent and fastening structure. After bending, the fastening structure touches the other end of the connection portion to be fixed on the connection board.

Comparing with the existed technology, the electrical connector device set an electrical connector piece. One end of the electrical connector pieces is related on the connection board through the connection portion. Meanwhile, the other end of connection portion is fixed on the connection board through the bent of the fastening structure. Bending the electrical connector pieces may make the resistance portion close to each other to become an elastic clipping portion. When assembled, just insert the connection board's insert terminal to the elastic clipping portion, and it may realize the electrical connection between the driver board and the light source board. The structure of the electrical connector device is simple. The electrical connector device does not need the artificial welding when assembled. The electrical connector device is easy to set. The electrical connector device owns the advantages of simple structure and easy to be assembled automatically.

### BRIEF DESCRIPTION OF DRAWINGS

FIG. 1 is the first embodiment stereoscopic drawing for the present invention, an electrical connector device.

FIG. 2 is the stereoscopic drawing from FIG. 1 that illustrates the electrical connector device.

FIG. 3 is the unfolded drawing from FIG. 2 that illustrates the connection board.

### DETAILED DESCRIPTION

Though the embodiment to describe the present invention detailed in following statement.

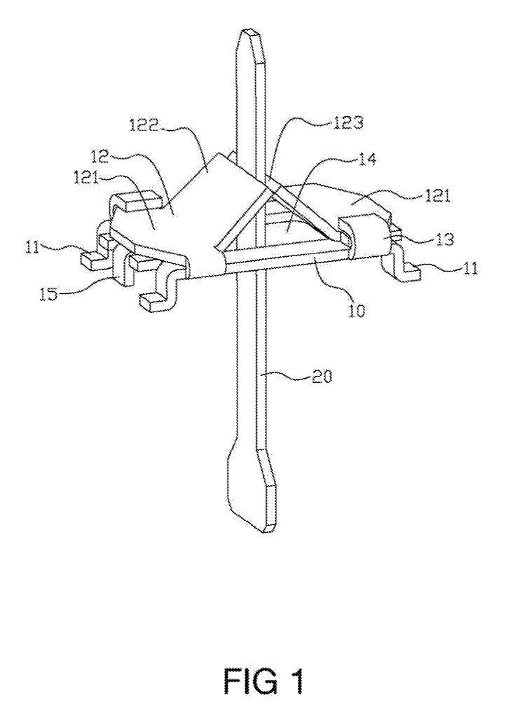

FIG. 1 is the first embodiment stereoscopic decomposition drawing for the present invention, an electrical connector device. The electrical connector device that connects a light source board and a driver board of an LED light electrically. The electrical connector device includes a connector board (10). The connector board (10) is related to the conductive pins (11). The connector board is fixed on the light source board and connected to the light source board electrically through the conductive pins (11).

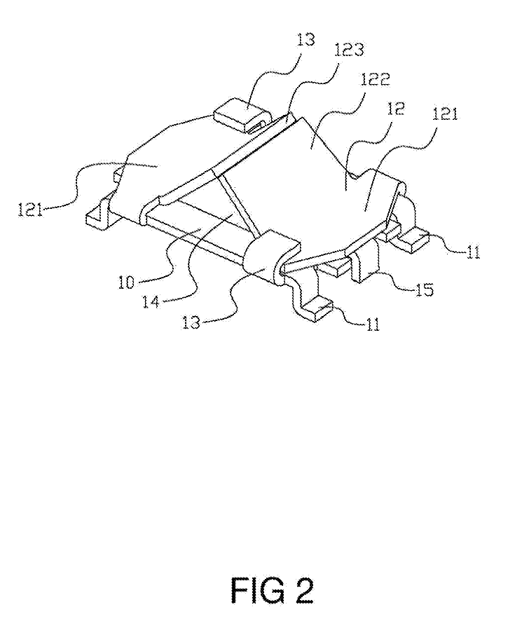

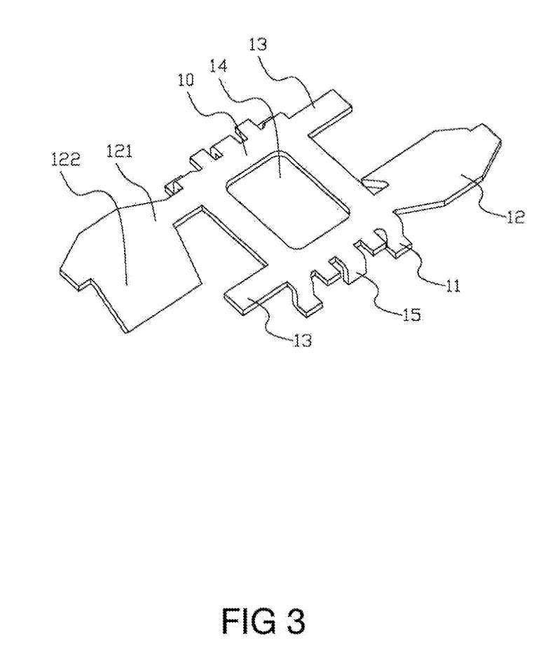

Based on FIG. 1 to FIG. 3, there are four conductive pins (11) in this embodiment. The conductive pins (11) are set around the connection board. (10) The conductive pins (11) are bent downside to be “Z” shaped structure from the side of the connection board. (10)

Moreover, the electrical connector device includes two electrical connector pieces (12). Each electrical connector piece (12) includes a whole set for the connection portion (121) and the resistance portion (122). One end of the connection portion (121) is fixed on the connection board (10). The resistance portion (122) of the electrical connector pieces (12) closes to each other to become an elastic clipping portion. (123) In the embodiment, the electrical connector pieces (12) are combined with the connection board. (10) The resistance portion (122) is bent in “ [symbol] ” shaped structure away from the connection board (10). Among them, the electrical connector pieces (12) is set on the opposite site of the connection board (10) and become a symmetry structure. Bending the electrical connector pieces (12) may close to each other to become an elastic clipping portion. (123) The electrical connector device also includes the bent and fastening structure (13). The fastening structure (13) is related to one end of the connection portion (121) after bending to fix the connection portion (121) on the connection board (10). The connection board (10) and the electrical connector piece (12) are made of metal ingredients. The fastening structure (13) are a whole set with the connection board (10). Moreover, the electrical connector device includes the supporting column. (15) One end of the supporting column (15) is related on the connection board (10). The other end of the supporting column (15) is related on the light source board to increase the ability that the electrical connector device defense the outer power and avoid the top of the electrical connector device be deformed by the outside squeeze.

Among them, the electrical connector device includes an insert terminal (20). One end of the insert terminal (20) is related to the driver board electrically. The middle of the connection board (10) is not own the insert hole (14). The elastic clipping portion (123) is set on the above of the insert hole (14). The other end of the insert terminal (20) is related to the elastic clipping portion (123) electrically after passing through the insert hole. (14)

In conclusion, the electrical connector device set the electrical connector piece (12). One end of the electrical connector pieces (12) is related on the connection board (10) through the connection portion (121). Meanwhile, the other end of connection portion (121) is fixed on the connection board (10) through the bent of the fastening structure (13). Bending the electrical connector pieces (12) may make the resistance portion (122) close to each other to become an elastic clipping portion (123). When assembled, just insert the connection board's insert terminal (20) to the elastic clipping portion, (123) and it may realize the electrical connection between the driver board and the light source board. The structure of the electrical connector device is simple. The electrical connector device does not need the artificial welding when assembled. The electrical connector device is easy to set. The electrical connector device owns the advantages of simple structure and easy to be assembled automatically. Moreover, the electrical connector pieces (12) may be more firm because one end of the electrical connector pieces (12) pass through the connection portion (121) and be related on the connection board; (10) meanwhile, passing through the bent of the fastening structure (13) to make the other end of the connection portion (121) be related on the connection board. (10) Even if the insert terminal insert to the electrical connector pieces (12) will push some pressure, the electrical connector device still not easily to be deformed and loss the function due to the two fixed ends of the electrical connector pieces. (12)

The statement above just for the better embodiment, not for limiting the present invention. All the modification, equal to any change and improvement that are based on the present invention's spirit and principle, may be protected in the present invention protection range.

1. An electrical connector device connecting a light source board and a driver board of an LED light electrically; characterized in that: the electrical connector device comprises a connector board; the connector board is related to the conductive pins; the connector board is fixed on the light source board and connected to the light source board electrically through the conductive pins; the electrical connector device also comprises two electrical connector pieces; each electrical connector piece comprises a whole set for the connection portion and the resistance portion; one end of the connection portion is fixed on the connection board; the resistance portion of the electrical connector piece closes to each other to become an elastic clipping portion and comprises the bent and fastening structure; after bending, the fastening structure touches the other end of the connection portion to be fixed on the connection board.

2. The electrical connector device of claim 1, characterized in that: the electrical connector pieces are combined with the connection board; the resistance portion is bent in “ [symbol] ” shaped structure away from the connection board.

3. The electrical connector device of claim 2, characterized in that: the connection board and the electrical connector piece are made of metal ingredients; the fastening structure is a whole set with the connection board.

4. The electrical connector device of claim 1, characterized in that: the electrical connector device includes an insert terminal; one end of the insert terminal is related to the driver board electrically; the middle of the connection board is not own the insert hole; the elastic clipping portion is set on the above of the insert hole; the other end of the insert terminal is related to the elastic clipping portion electrically after passing through the insert hole.

5. The electrical connector device of claim 1, characterized in that: the electrical connector pieces are set on the opposite site of the connection board and become a symmetry structure.

6. The electrical connector device of claim 1, characterized in that: including four conductive pins; the conductive pins are set around the connection board; the conductive pins are bent downside to be “Z” shaped structure from the side of the connection board.

7. The electrical connector device of claim 1, characterized in that: including the supporting column; one end of the supporting column is related on the connection board; the other end of the supporting column is related on the light source board.
